(19) United States
(12) Patent Application Publication
(10) Pub. No.: US 2003/0091093 A1
(43) Pub. Date: May 15, 2003

(54) Temperature sensor and a method for bonding a temperature sensor

(76) Inventors: Heinrich Zitzmann, Lauf an der Pegnitz (DE); Georg Bernitz, Nuernberg (DE)

Correspondence Address: Dougherty Clements & Hofer, Suite 400, 6230 Fairview Road, Charlotte, NC, 28210, US

(21) Appl. No.: 10/239,799

(22) PCT Filed: Apr. 24, 2001
(86) PCT No.: PCT/EP01/04617

(30) Foreign Application Priority Data
Apr. 28, 2000 (DE) 10020931.9

(51) Int. Cl. G01K 1/00

(52) U.S. Cl. 374/185; 374/208

(57) ABSTRACT

In a method of contacting a temperature measurement sensing device having connecting wires, after applying the connecting wires, they are oxidized before they are fixed by means of a fixing glaze.

### BACKGROUND OF THE INVENTION

1. Field of the Invention

The present invention relates to a temperature measurement sensing device and to a method of contacting a connecting wire at a contact pad of the temperature measurement sensing device.

2. Description of the Related Art

For many years, temperature measurement sensing devices have been produced in thin layer technology in different embodiments and used for precise temperature measurement tasks.

A known temperature measurement sensing device is shown in FIG. 3. On an Al₂O₃ ceramic support 300, a platinum layer 302 having a thickness of about 1 μm is applied. This platinum film 302 is structured in such a way that it has a resistor trace of, for example, 100 Ω. For the protection of the platinum layer 302, it is covered by a suitable protective layer 310. Connecting wires 308 are welded thereto at two contact areas 306. In order to ensure a mechanical load of the connecting wires 308, a fixing glaze 304 is applied to additionally fix the connecting wires 302 mechanically. The fixing glaze 304 is burnt in at temperatures around about 800° C. (the glaze must melt) to provide a usage temperature of up to 600° C. (glaze must not soften).

In known temperature measurement sensing devices, due to the high burning-in temperature, connecting wires made of a noble metal (such as, for example, platinum or palladium) or noble metal alloys (such as, for example, gold, palladium) or wires having a sufficiently thick noble metal cover (such as, for example, nickel having a platinum cover) are used for the connecting wires 308. In some temperature measurement sensing devices, silver wires or wires made of a silver palladium alloy are also used. These noble metal wires are, however, relatively expensive and thus it is desirable to use cheaper wires for this. They can, for example, be made of nickel or nickel alloys. Nickel wires have very good mechanical characteristics and can be welded very well to wire extensions required. In addition, nickel wires have a very high continuous usage temperature of up to about 600° C., which is considerably higher than that of silver (400° C.).

The disadvantage of nickel wires is that the nickel chemically reacts with the fixing glaze mass of the fixing drop in the burning-in process of the fixing glaze drop for a wire fixing when the melting phase is reached during the burning-in process. Due to this chemical reaction, in the glaze mass surrounding the connecting wires 308 at the contact areas 306 of the sensor chip, many small bubbles 312 form, as is shown in FIG. 4, in the wetting area towards the wire surface. These bubbles 312 diminish the fixing quality, i.e. the maximum permitted extension forces at the connecting wires 308 are reduced considerably. These problems especially occur when burning in in a protective atmosphere (such as, for example, forming gas N₂/H₂, 95:5).

A further problem in the burning-in process in normal air is that, after the burning in, an oxide layer has to be removed at the nickel wire ends in order to enable a reliable contacting to the measuring cable.

Even in the nickel wires described above covered by a noble metal such problems arise, as is shown in FIG. 5. These wires do not have a platinum cover 316 at the end faces (interfaces) so that there are bubbles 314 at this wire end under the fixing glaze 304 after burning in.

DD 289 127 A5 describes a platinum thin layer sensor made of a ceramic substrate, a platinum thin layer and two contact areas. In order to achieve a high bonding with the substrate, the contact areas and the connecting wires or a high mechanical strength of the connection in tension/compression and shear forces as well as in extreme temperature changes, the connecting wires made of platinum and silver alloys are embedded into a bonding glaze having a high strength and a low extension coefficient.

DE 196 05 468 C2 describes a platinum temperature sensor having an insulated substrate. A platinum film circuit and a heat-producing device are arranged on the substrate. At the platinum film circuit, a cover having a low thermal conductibility is arranged as the insulating substrate. Connecting wires are electrically connected to the substrate and secured thereon by means of a glaze.

### SUMMARY OF THE INVENTION

It is the object of the present invention to provide a method of contacting a temperature measurement sensing device and a temperature measurement sensing device having cheap connecting wires at an increased fixing quality.

The present invention is a method of contacting a temperature measurement sensing device, in which a connecting wire is secured at a contact pad of the temperature measurement sensing device, the secured connecting wire is oxidized and the connecting wire is fixed by means of a fixing glaze.

In addition, the present invention is a temperature measurement sensing device having a resistor layer and a connection wire connected to a contact pad of the temperature measurement sensing device and secured by the fixing glaze, the connection wire comprising an oxide layer at least in the area of the fixing glaze.

In a preferred embodiment, the connecting wires are made of nickel, a nickel alloy (such as, for example, NiCr) or a nickel wire having a platinum cover, wherein the platinum cover is not completely closed at the end faces and voids, for example.

The present invention is based on the recognition that the glaze used for fixing does not react with the oxide layer when melting so that the problems arising in the prior art can be prevented when using, for example, nickel wires by oxidizing them after connecting and before fixing. In this way inhomogeneities, such as, for example, in the form of bubbles, are prevented from forming at the interface between the wire and the fixing glaze, whereby in spite of the cheap materials of the wire a high fixing quality is obtained. The connecting wire is made of a material which, when fixing with a fixing glaze, reacts in such a way that bubbles form at the interface between the connecting wire and the fixing glaze.

It is an advantage of the present invention that, by oxidizing the nickel wire, a stronger anchorage of the oxidized nickel wire with the glaze is obtained than is the case when using noble metal wires.

A further advantage of the present invention is that the nickel wires preferably used can be welded very well to wire extensions to the measuring circuit.

A further advantage is that the continuous usage temperature of nickel or nickel alloys is high (600° C.), even higher than that of silver (400° C.) and that nickel has good mechanical characteristics.

### BRIEF DESCRIPTION OF THE DRAWINGS

Preferred embodiments of the present invention will be detailed subsequently referring to the appended drawings in which:

FIG. 1 is an illustration of a contacted nickel wire at a temperature measurement sensing device according to a first embodiment;

FIG. 2 is an illustration of a contacted nickel wire having a platinum coat according to a second embodiment;

FIG. 3a is a top view of a known temperature measurement sensing device;

FIG. 3b is a side view of the known temperature measurement sensing device of FIG. 3a;

FIG. 4 is an illustration of a contacted nickel wire in which, due to a chemical reaction, there are small bubbles in the glazing mass in the wetting area towards the wire surface; and

FIG. 5 is an illustration of a contacted nickel wire having a platinum coat, in which, due to a chemical reaction, there are small bubbles in the glazing mass in the wetting area towards the wire surface.

### DESCRIPTION OF THE PREFERRED EMBODIMENTS

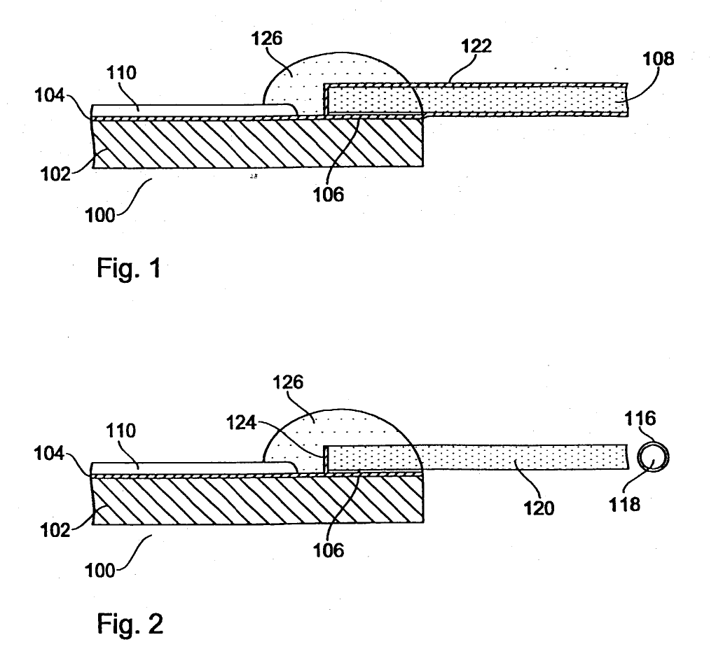

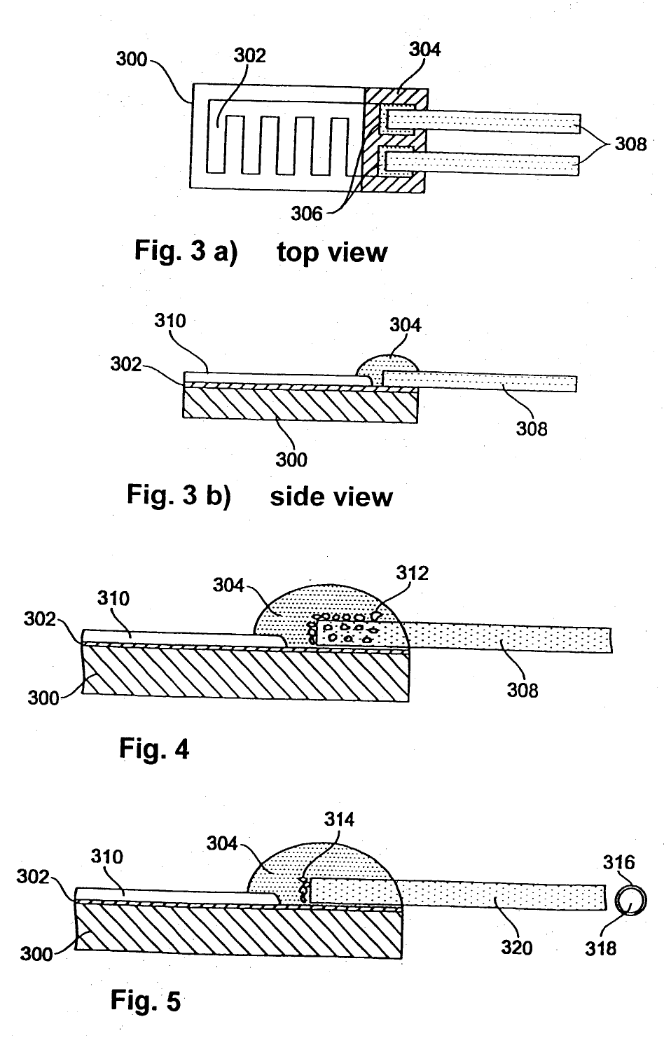

A first preferred embodiment of the present invention is shown in FIG. 1. A temperature measurement sensing device 100 includes a substrate 102 onto which a platinum resistor layer 104 is formed, which is connected to a connection area or a contact pad 106 via which the electrical signals are led to or from the platinum layer. A nickel wire 108 is electrically connected to the contact pad 106 (for example by bonding). Unlike known sensing devices, no fixing glaze 126 is applied, but the applied nickel wire 108 is surface-oxidized in a further step by, for example, subjecting the nickel wire 108 (including the chip) for about 30 minutes to a temperature of 800° C. in normal atmosphere. Thus the nickel wire 108 is covered by a thin oxide layer 122. Then the fixing glaze 126 is applied and burnt in at 800° C. so that the structure shown in FIG. 1 results. The oxide layer 122 causes a reaction of the nickel and the glazing mass during the melting process to be prevented. The formation of bubbles no longer occurs and the tensile force of the nickel wire 108 is increased significantly. The oxide layer 122 combines well with the surrounding glaze so that the anchorage of the oxidized nickel wire 108 with the glaze is even stronger than in the case of the noble metal wires.

The oxide layer 122 on the surface of the nickel wire 108 is, however, formed over the entire length, but is unwanted at the wire end where the electrical connection (welding, (hard) soldering or crimping) to a measuring cable is to take place. Because of this, after burning in the fixing glaze 126, the sensor elements are subjected to a reduction process in an additional step in which the exposed nickel oxide layer is deprived of the oxygen again and finally a bare nickel wire is present again. This reduction process can, for example, occur in an N₂/H₂ atmosphere at about 600° C. Since the connection area 106 and the nickel wire 108 are covered by the fixing mass in this area, the tensile force of the wires obtained before is thus not impaired.

The reduction in the N₂/H₂ atmosphere has the advantage for those applications in which a tinning of the wire ends is desired, that the nickel wires can be tinned easily immediately after the reduction.

A further possibility to free the wires 108, 120 of the oxide layer 122, 124 is a mechanical cleaning, such as, for example, sand blasting.

In FIG. 2, a second preferred embodiment of the present invention is shown. Compared to the embodiment shown in FIG. 1, the embodiment shown in FIG. 2 differs by the connecting wire 120 being a nickel wire 118 having a platinum cover 116. Since the connecting wire 120 does not have a platinum cover 116 at the end face (interface), the connecting wire 120 is oxidized at the connection area 106 after welding (bonding). Then the fixing glaze 126 is applied and burnt in. By means of this oxidation, a formation of bubbles at the end faces of the connecting wire 120 is prevented, whereby an improvement of the connecting wire fixing is obtained.

The oxide layer 124 on the nickel face of the connecting wire can then be removed by means of a reduction treatment, whereby the tinnability (wetting) is improved although this is not necessarily required due to the platinum coat.

With the help of FIGS. 1 and 2, preferred embodiments of the present invention have been described in detail, the present invention not being limited to these embodiments.

In addition, the fixing glaze, depending on the melting range of the glaze used, can be burnt in in a temperature range between 500° C. and 1000° C.

The nickel wire can further be oxidized in a temperature range between 600° C. and 900° C. for a duration of 5 minutes to 60 minutes.

What is claimed is:

1. A method of contacting a temperature measurement sensing device, comprising the following steps:
securing a connecting wire at a contact pad of the temperature measurement sensing device;
oxidizing the secured connecting wire; and
fixing the connecting wire by means of a fixing glaze.

2. The method according to claim 1, wherein the connecting wire is made of nickel, a nickel alloy or nickel having a platinum coat.

3. The method according to claim 1, wherein the connecting wire is coated by a noble metal layer in such a way that an end face of same is exposed.

4. The method according to claim 1, comprising the following step:
removing the oxide layer from the end of the connecting wire, which is arranged distant from the temperature measurement sensing device.

5. A temperature measurement sensing device comprising:
a resistor layer; and
a connecting wire connected to a contact pad and secured by a fixing glaze, the connecting wire including an oxide layer at least in the range of the fixing glaze.
